(19) United States
(12) Patent Application Publication
(10) Pub. No.: US 2010/0161412 A1
(43) Pub. Date: Jun. 24, 2010

(54) Method for releasing the PDF document and delivering the relevant advertisement

(76) Inventor: Yuqian Xiong, Fujian (CN)

Correspondence Address: Raymond Y. Chan, 108 NorthYnez Avenue, Suite 128, Monterey Park, CA, 91754, US

(21) Appl. No.: 12/308,350

(22) PCT Filed: Jun. 20, 2006
(86) PCT No.: PCT/CN2006/001396

§ 371 Date: Dec. 12, 2008

(51) Int. Cl. G06Q 30/00; G06F 17/00

(52) U.S. Cl. 705/14.49; 715/234

(57) ABSTRACT

A scheme of the present method publishes the PDF electronic documents on the Website of the Internet and displays the related advertisement supplied by the advertisement provider to the reader according to the content of the PDF document read by the reader. The method includes: saving the PDF document on the website, transforming the PDF document into the text file with no format and displaying the PDF file to the reader, transmitting the corresponding text with no format to the advertisement agency, receiving and displaying the related advertisement to the reader.

### BACKGROUND OF THE PRESENT INVENTION

1. Field of Invention

This invention pertains to a method for releasing PDF documents on the Website of the Internet and displays the related advertisements to the reader according to the content of the PDF document read by the reader.

2. Description of Related Arts

With the development of the Internet, more and more users refer to reading e-magazine's to get information via the Internet. In consequence, publishers propose to run internet bookstores and release e-books to reap profits on the Internet.

At the present time, publishers usually make consumers pay for e-magazines by providing them with the table of contents or certain chapters of a book for the consumer to preview. However, this method is limited on generating high profits because of security issues in payment, pirated e-books, and reader's unwilling to purchase. If the e-magazine's authors or publishers cannot gain profit fast and easily, they may not want to release e-magazines over the internet.

As for the consumers, deciding to pay for an e-book by just reading certain chapters or the table of the contents is too risky. Most of the time, the e-book can be read just once, and will not be read again. So why would the consumer consider purchasing e-books?

The publishers and their agents spent time and advertising money promoting their products with ineffective results due to advertising campaigns not being addressable enough.

### SUMMARY OF THE PRESENT INVENTION

The present invention relates to a method for releasing PDF documents and delivering the relevant advertisement. This invention helps the publishers to gain profit by supplying the advertisement while publishing the PDF electronic documents on the Website of the Internet for free. In this case, consumers are able to read free PDF documents by viewing and clicking on the advertisement, while advertisement providers can deliver the highly-related advertisement to the readers.

This method includes the following steps:

(a) Saving the PDF electronic document on the Website of the Internet;

(b) Transforming the PDF document into the text file;

(c) Displaying the PDF file and providing end-use PDF viewer (Web Browser Plug-in) to the reader or displaying the PDF file in web image format;

(d) Transmitting the corresponding text to the advertisement agency; and

(e) Receiving the highly-related advertisement from the advertisement provider, including images, text, and multimedia, and showing in PDF viewer.

These and other objectives, features, and advantages of the present invention will become apparent from the following detailed description, the accompanying drawings, and the appended claims.

### BRIEF DESCRIPTION OF THE DRAWINGS

FIG. 1 is a flowchart of this invention releasing PDF documents and delivering the relevant advertisement.

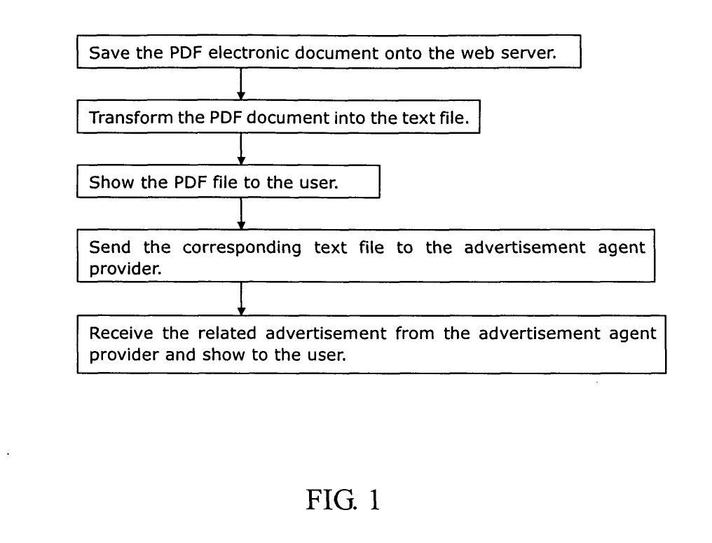

### DETAILED DESCRIPTION OF THE PREFERRED EMBODIMENT

This invention includes the following steps:

(1) Saving the PDF electronic document on the Website of the Internet. The website can be the publisher's own website. As for the individuals, they can save the PDF document on the website of the third party professional publishers.

(2) Transforming the PDF document into the text file. A PDF file has just one transformation, which will rebuild the lost text flow of the PDF file. After the transformation, the text file will be stored on the web server as well, correlating to the PDF file.

(3) Displaying the PDF file to consumers by either providing end-use PDF viewer (Web Browser Plug-in) for consumers to view PDF or displaying the PDF file in web image format. The web browser plug-in is customized by different web browsers, which only needs to be installed at the first time the consumer views the PDF file. Consumers are not required to install any plug-ins if the PDF is displayed in web image format.

(4) Transmitting the corresponding text to the advertisement agency. Publishers can either send the current page or the entire text file. According to the text file, the advertisement provider will find out the highly-related advertisement for the PDF file after their keyword match between the text file and their advertisement library is done.

(5) Receiving the highly-related advertisement from the advertisement provider and showing in PDF viewer. Consumers will view and click on the advertisement or even purchase the product or the service shown in the advertisement if they have interest in it. Manufacturers of the products will pay commissions to the advertisement provider by per click advertising or purchase products shown in the ad, which the advertisement provider and the publisher share together. This is a Win-Win situation that can be achieved with this invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of releasing a PDF electronic document and delivering a relevant advertisement, comprising the steps of:
(a) saving the PDF electronic document on a Website of an Internet;
(b) transforming the PDF document into a text file;
(c) displaying the PDF document and providing an end-use PDF viewer (Web Browser Plug-in) to a consumer or displaying the PDF document in a web image format;
(d) transmitting a corresponding text of the text file to an advertisement agency; and
(e) receiving a highly-related advertisement from the advertisement agency, including images, text, and multimedia, and showing in a PDF viewer.
